(19) United States
(12) Patent Application Publication
(10) Pub. No.: US 2012/0240525 A1
(43) Pub. Date: Sep. 27, 2012

(54) Method and System for Applying Tamper Evident Banding

(76) Inventor: Wayne C. Summerford, Pittsfield, NH (US)

(21) Appl. No.: 13/429,922

(22) Filed: Mar. 26, 2012

Related U.S. Application Data
(60) Provisional application No. 61/467,700, filed on Mar. 25, 2011.

(51) Int. Cl. B65B 53/02; B65G 37/00

(52) U.S. Cl. 53/442; 53/138.1; 198/620

(57) ABSTRACT

A shrink band application machine includes a conveyor system for packaging to apply a heat shrinkable band that can provide evidence of tampering. The machine allows the placement of shrink bands on randomly spaced and randomly shaped containers in the same run. In one embodiment, the invention utilizes single wound film for form the shrink band and avoids the need stock and setup the system for different shapes or sizes of shrink bands to accommodate different sizes and shapes of containers. Some embodiments of the invention can utilize single wound film and create a shrink film band buy fusing or sealing together two webs of single wound film around the container. This eliminates the need to change from one shrink tube size to another when changing the size of the container.

### CROSS-REFERENCE TO RELATED APPLICATIONS

This application claims any and all benefits as provided by law of U.S. including benefit under 35 U.S.C. §119(e) of Provisional Application No. 61/467,700 filed Mar. 25, 2011, which is hereby incorporated by reference in its entirety.

### STATEMENT REGARDING FEDERALLY SPONSORED RESEARCH

Not Applicable

### REFERENCE TO MICROFICHE APPENDIX

Not Applicable

### BACKGROUND

1. Technical Field of the Invention

The present invention is directed to tamper evident security bands and seals. More specifically, the present invention is directed methods and systems for applying tamper evident bands and seals on bottles, containers and other packaging.

2. Description of the Prior Art

Tamper evident banding is used in the food industry, the pharmaceutical industry as well as other industries, to indicate if a packaging has been opened or otherwise tampered with. Shrink banding is one of several common devices used to indicate if a package has been tampered with. In most cases tamper evident banding with shrink bands is applied by shrinking a heat shrinkable film around the lid of a container. In many cases the shape or size of the container mandates that the band of shrink film be held in physically place until the film is shrunk onto the container. If the band is not held in place it may fall towards the base of the container or it may sag out of position. In some cases the container itself is shaped to accomplish this, in other cases there needs to be a device to hold the film. To date there have been several different conveyors designed to hold the bands in place while the band shrinks. All of the conveyors to date are limited to specific shapes and sizes because of the fact that the conveyor is rigid and doesn't conform to the container. If the shrink band is not supported the band may fall to the bottom of the container or it may shift and create a product that is not tamper evident or will be rejected at market.

Another way to create a tamper evident seal is to utilize what are known in the industry as preformed shrink bands. A preformed shrink band is made by utilizing shrink film that is in the form of a tube. The tubing is cut to a specific length and is then placed on an aluminum mold by hand. The mold mimics the shape of a particular container. The shrink film is then preshrunk and it takes the form of the preform mold. The band forms a lip over the top of the mold and the sides are tapered inward towards the top. This lip allows for the bands to be placed over a container without falling to the base of the container. The lip catches on the top of the container. The preforms are tapered so they can nest into one another. The preforms are stacked onto each other for distribution to manufactures. The manufactures apply the preformed shrink band to the container and the lip on the preform holds the film in place until it is shrunk around the container. Preformed shrink bands are logistically difficult because there are hundreds of different sizes and shapes. They are also very expensive to transport because they have a low volume to weight ration. The present invention will eliminate the need for preformed shrink bands in most cases.

Tamper band application machines to date utilize tubular shrink film. In most cases different containers need different size tubular shrink film. The present invention will drastically reduce the multiple sizes of tubular film needed for different containers because it forms different size bands from single wound film.

### SUMMARY

The present invention is directed to a method and system for supporting a band that shrinks when heated around a container. The band can be used to seal the container as well as provide evidence of tampering The invention provides for consistent placement of shrink bands on containers. It also provides for flexibility in container change over as well as flexibility in different shapes and sizes of containers without requiring the change parts conveyor parts and with minimum or no setup. Machines and systems according to the present invention can accept containers that are randomly spaced and have different shapes and sizes in same run. In some embodiments of the present invention, the shrink band can be form from a single wound shrink film in order to create different size bands around different size, randomly arranged containers. These bands can be shrunk to create a tamper evident sealed package. The horizontal flexible mover elements allow embodiments of the present invention to adapt to other types of banding operations. The horizontal flexible mover elements according to the invention can be used with existing banding methods and machines as well as the shrink banding method set forth in the present invention.

It is an object of the present invention to provide a conveyor system that will hold a tamper evident band in the correct position to create a tamper evident package.

Another object of the present invention conveyor system is to efficiently apply taper evident bands to a series of containers being conveyed on a conveyor.

Another object of the present invention conveyor system is to provide a system to accurately apply tamper evident bands to a various size and various shape containers.

Another object of the present invention conveyor system is to apply tamper evident bands to containers of relatively narrow widths.

Another object of the present invention conveyor system is to apply tamper evident bands about a container at specific positions of the container.

Another object of the present invention conveyor system is to eliminate the need for change parts when running a relatively large variety of sizes as well as a relatively large variety of shapes of containers.

Another object of the present invention conveyor system is to provide a flexible foundation for the tamper evident shrink film to rest on that maintains a consistent height.

Another object of the present invention conveyor system is to provide adjustment in both width and height by means of hand cranks or motors.

Another object of the present invention is to accept packages randomly or with consistent spacing.

Another object of the present invention is to utilize single wound film to create band of film around a container.

### BRIEF DESCRIPTION OF THE FIGURES

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a side view of an embodiment of the present invention. This view shows the bottom carry belt as well as the horizontal movers and there relative locations. This figure also shows a shrink band resting on the horizontal mover elements. The figure shows the adjustment crank for height of the horizontal movers relative to the carry conveyor.

FIG. 2 shows a top elevation view of an embodiment of the present invention with the guards removed. This view shows the horizontal movers as well as the flexible mover elements. This view demonstrated how the flexible mover elements conform to random shapes and sizes of containers.

FIG. 3 shows a top elevation view of an embodiment of present invention. This figure shows the flexible mover elements that conform to the container. It also shows the webs of single wound film encapsulating a container. The sealing section of the conveyor is shown in this view as well as the heat zone of the conveyor. This figure also shows the side adjustment crank.

FIG. 4 shows how finger style movers also conform to the outside edges of a container.

FIG. 5 shows a diagrammatic view of an alternative embodiment of the invention.

### DETAILED DESCRIPTION OF EMBODIMENTS

The present invention is directed to methods, apparatus, and systems for supporting and applying shrink bands on containers that can provide a tamper evident seal. In accordance with one embodiment of the present invention, an apparatus can support a shrink band in position relative to a container in order to convey the container through a system that can apply a heat shrinkable film around the circumference of the container that can provide tamper evident seal. In accordance with the invention, the apparatus can accommodate many containers having different shapes and sizes in the same run, without needing to change the setup of the machine.

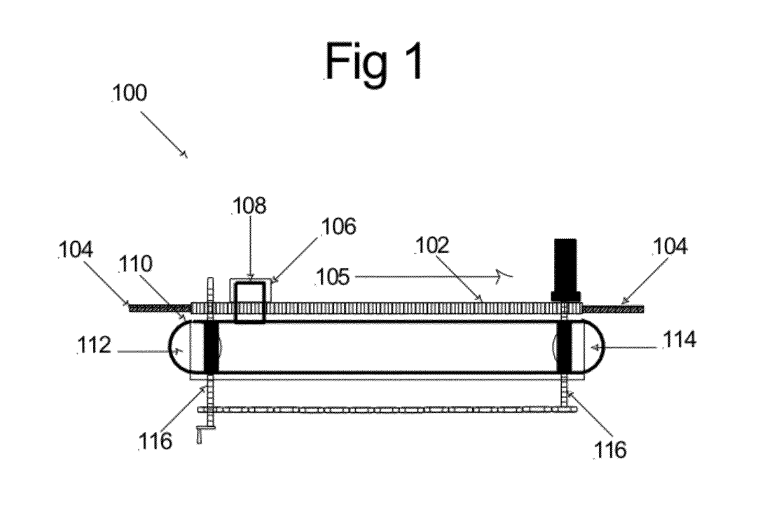

As shown in FIGS. 1, 2 and 3, the band application machine 100, 200, 300 according to one embodiment of the invention includes a bottom carry conveyor 110, 210, 310, a pair of horizontal movers 102, 202, 302, flexible mover elements 104, 204, 304, lead screws for height 116 as well as width 320 adjustment, film feed system 322, the sealing device 326, and the heat zone 218, 318 for shrinking of the film 106, 206, 306.

FIG. 1 shows a side view of the system according to an embodiment of the invention (the protective guards and the underlying support frame are not shown). The bottom carry conveyor belt 110 can be designed and adapted to hold the weight of the container or package 108 and move it forward along a horizontal axis 105 from the loading position through a seal applying station 122 for applying a tamper evident shrink band 106 and a heat zone 130 for shrinking the band 106 into place on a container 108. The bottom carry conveyor can be a conventional conveyor utilizing a belt 110 and support rollers 112. As seen in FIG. 1, the horizontal movers 102 can be positioned above the bottom carry conveyor belt 110 and extend parallel to horizontal axis 105 along either side of the conveyor 110. In some embodiments, only one horizontal mover 102 can be provided on one side of the conveyor and a guiding edge or wall can be provided on the other side of the conveyor 110. In accordance with one embodiment of the invention, the horizontal movers 102 can be configured to move at the approximately the same speed horizontally as the bottom carry conveyor belt 110. The horizontal movers 102 can be mechanically or electronically coupled to the conveyor 110 to enable the horizontal movers 102 and the conveyor 110 to move at substantially the same speed. The mechanical coupling can include gears, chains and sprockets and/or cables and pulleys that mechanically connect the conveyor 110 and one or more of the horizontal movers 102. The electrical coupling can include a speed sensor, such as an encoder wheel, that measures the speed and direction of the conveyor and sends a signal to a motion controller that controls the speed and direction of at least one of the horizontal movers 102.

In accordance with one embodiment of the invention, the horizontal movers 102 can include one or more flexible mover elements 104 projecting in a horizontal direction substantially perpendicular or transverse to the horizontal axis 105. The flexible mover elements 104 can be substantially flexible in the horizontal direction and substantially supportive in the vertical direction such that the mover elements 104 conform around the shape of any container traveling on the conveyor 110, while at the same time supporting the shrink band at a predefined height above the conveyor 110. In accordance with the invention, the flexible mover elements support the shrink band 106 in a predefined position vertically, with respect to the container 108. In accordance with some embodiments of the invention, the horizontal movers 102 can be adjustable by lead screws 116 to allow the horizontal movers 102 to be raised or lowered above the bottom carry conveyor belt 110 to adjust the position of the tamper evident band 106 vertically relative to the container 108 and the conveyor 110.

In accordance with some embodiments of the invention, the bottom carrying conveyor belt 110 moves one or more containers in a horizontal direction along a horizontal axis 105 while supporting the weight of the container. The conveyor 110 can include one or more conveyor belts and each belt can range from less than 1 inch wide to more than 16 inches wide, depending on the width of the containers to be processed. The conveyor 110 can also include turns as well as rising and lowering portions to move the container toward the shrink band applying station and the heating station. One example of a conveyor is the model BCLP105 manufactured by L.K. Goodwin Co., Inc., Providence, R.I. The drive for this conveyor can be powered by an AC power source or a DC power source. The conveyor belt can include a smooth finish carry belt or a rough finish on the carry belt. This conveyor can be mounted on a frame and remain stationary or it can be adjusted up and down along lead screws to position the container at different heights.

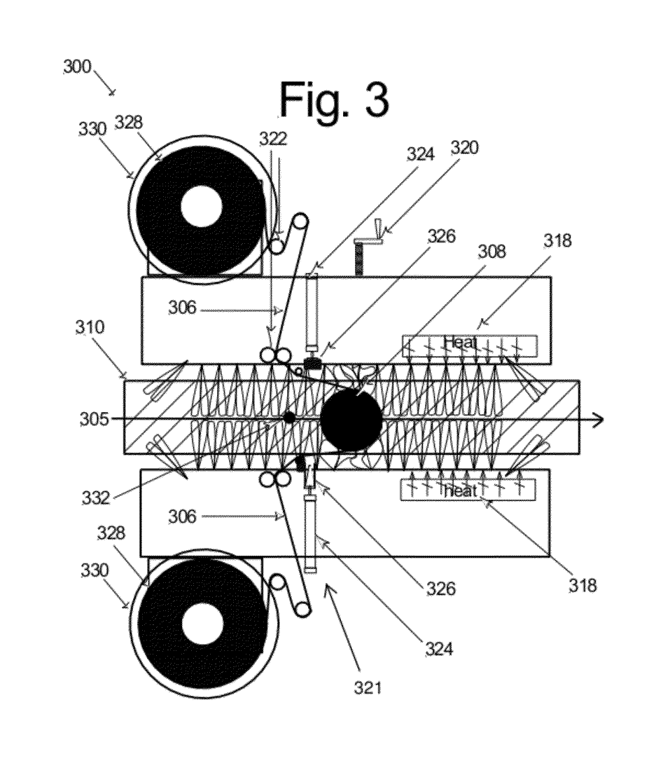

In accordance with some embodiments of the invention, the horizontal movers 102 move at the same relative speed as the bottom carry conveyor belt 110. The horizontal movers 102 and the conveyor 110 can be driven by the same motor or by different motors wherein the motion is synchronized or running at the same speed. In accordance with the invention, the horizontal mover 102 can support and carry the flexible mover elements 104 at a preset height relative to the conveyor 110. The Flexible mover elements 104 can be incorporated into the horizontal movers 102 or they may be attached to elements the horizontal movers 102. In one embodiment, the horizontal movers 102 can include chain supported by two or more sprockets, each rotating about a vertical axis. In one embodiment, the chain includes an ANSI Roller Chain Attachment Connecting Link Style D-1 for #40 Chain. This type of connecting link can be used on a #40 chain to provide a connection point for one or more flexible mover elements 104 that are connected to the horizontal movers 102. In one embodiment, one or more of the chain links can include a post extending vertically from the horizontal surface of the link and one or more flexible mover elements can be removably clamped or fastened by fasteners (e.g., screws, bolts, rivets, pins) to the post. In some embodiments of the invention, the flexible mover elements can pivot on the post and in other embodiments the flexible mover elements can be fixed to the post. In an alternative embodiment, the horizontal movers 102 can include a drive belt supported by two or more pulleys, each rotating about a vertical axis. The drive belts used in horizontal movers 102 can be toothed or smooth. In some embodiments, the flexible mover elements can be removably fastened to the drive belt using fasteners (e.g., screws, bolts, rivets, clamps, staples). In some embodiments, the flexible mover elements can be space from 1/32 of an inch to more than 4 inches apart on the chain or belt, depending on the design of the flexible mover elements. In one embodiment, the belt can be a profile belt manufactured by Gates Mectrol, Inc, Salem N.H. As shown in FIG. 3, the horizontal movers 102 can be mounted in a perpendicular fashion to the bottom carry conveyor belt 110. In an alternative embodiment, the horizontal movers 102 can be mounted to extend in a parallel plane to the bottom carry conveyor 110. In one embodiment, the function of the horizontal mover 102 is to move the flexible mover elements 104 at substantially the same speed as the container that is traveling on the bottom carry conveyor belt 110. The horizontal movers 102 travel in the same direction as the bottom carry conveyor belt 10.

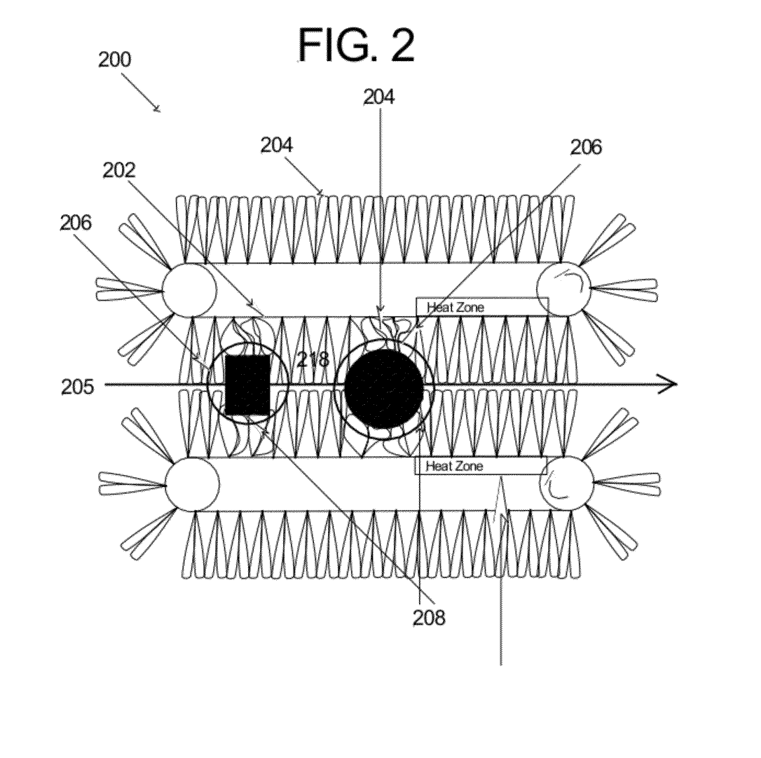

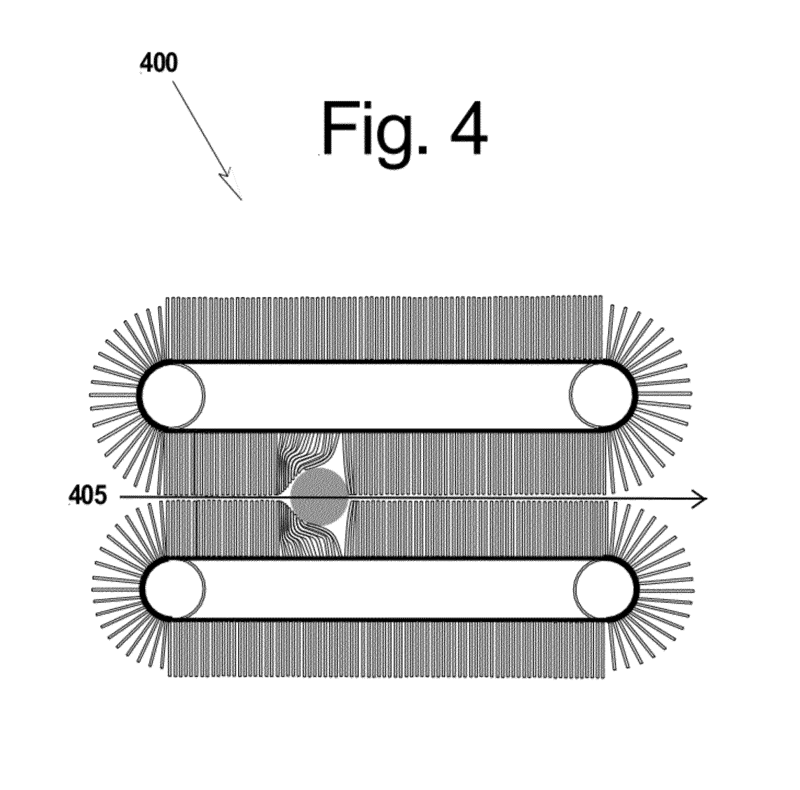

In one embodiment, the function of the flexible mover elements 104 is to move at substantially the same speed as the container 108 and conform to the outer surfaces of the container as it travels on the bottom carry conveyor belt 10. The flexible mover elements 104 can also support the shrink film 106 in position relative to the container 108 and transport it along with the container 108 as it is conveyed forward on the bottom carry conveyor belt 10 through the heat station. In one embodiment, the flexible mover elements 104 can conform in a random fashion and are not used for indexing or spacing of the containers 108 along the conveyor 110. The flexible mover elements 04 can be attached to the horizontal movers 102, or they can be an integral part of the horizontal movers 102. The flexible mover elements 104 can be molded into the horizontal movers 110 or they can be fastened, such as by welding, brazing, soldering, bolting, riveting or gluing them to the horizontal movers 110. In one embodiment, the belt is manufactured by F.N. Sheppard & Co. Erlanger, Ky. In one embodiment of the invention, the flexible mover elements 104 can be formed by making a loop of a flat strip of flexible material as shown in FIG. 2. In other embodiments of the invention, the flexible mover elements 104, can be formed from a flexible material in the shape of a bristle or finger as shown in FIG. 4. The general shape of the flexible mover elements 104 is not as important as its ability to conform to the outside surfaces of the container 108. In accordance with one embodiment of the invention, the flexible mover elements 104 can be made from Teflon impregnated cloth, or a silicon rubber based or coated material. Other types of flexible polymer materials that can enable a the flexible mover elements 104 to conform to the outside of the container and support the shrink band material can also be use. In some embodiments of the invention, each flexible mover element can be formed from a single loop of 0.25-5 inch wide strip of Teflon impregnated cloth, bent into a loop with the free ends fastened to the chain or belt that makes up the horizontal mover 110. In other embodiments of the invention, each flexible mover element can be formed from two or more loops of 0.25-5 inch wide strip of Teflon impregnated cloth, bent into a loop with the free ends fastened to the chain or belt that makes up the horizontal mover 110. The width of the strips of material (e.g., Teflon impregnated cloth) or the thickness of the flexible mover elements can be selected to provide support for the shrink band and enable positioning of the shrink band relative to the container. In some embodiments, the width of the strips (or the thickness of the flexible mover elements) is selected to be less than the height of the shrink band above the conveyor 110 and is preferably selected to be as small as possible to accommodate short containers.

In alternative embodiments, brushes or springs can also be used as flexible mover elements. In some embodiments, the flexible mover elements 104 can be fabricated from many different materials and each element can have a different flexibility in a different direction. Some examples of the items listed above can be obtained from the following list of companies.

Taconic Plastics Petersburgh, N.Y.—Teflon impregnated cloth

AAACME Rubber Company Tempe, Ariz.—Silicon Rubber

Jones Spring Company Inc. Wilder, Ky.—Springs

Felton Brush Company Londonderry, N.H.—Brushes

In accordance with some embodiments of the invention, the horizontal movers 110 can be provided with height adjustment and width adjustment. In one embodiment, the horizontal movers 110 can be mounted to adjustment lead screws 116 that can raise or lower the horizontal movers 110 by turning the lead screw in one direction or another to adjust the height of the flexible mover elements 104 relative to the conveyor belt 110 and position the heat shrink bands relative to the container 108 and allow for different placement of the shrink film 106 on the container 108. The height adjustment can be accomplished by either moving the bottom carry conveyor belt 110 up and down or moving the horizontal movers 102 up and down. The adjustment can be accomplished by a hand crank with adjustment screws, hydraulic lifters, pneumatic lifters, or any type of linear actuator in the vertical plane. In accordance with some embodiments of the invention, automatic methods can be utilized to provide for automatic height adjustment for different height containers entering the machine in a random fashion. Sensors can be provided at the entrance and/or along the length of the conveyor to sense the height of the container and adjust the height adjusters automatically.

In accordance with some embodiments of the invention, the horizontal movers 110 can be mounted to width adjustment lead screws that can move the horizontal movers 102 in and out relative to the center of the bottom carrying conveyor belt 110. The width adjustment allows the flexible mover elements 104 to moved closer together to accept narrower container and allows the flexible mover elements 104 to move apart to accept wider containers. The adjustment can be accomplished by a hand crank with adjustment screws, hydraulic lifters, pneumatic lifters, or any type of linear actuator in the horizontal plane. In accordance with some embodiments of the invention, automatic methods can be utilized to provide for automatic width adjustment for different width containers entering the machine in a random fashion. Sensors can be provided at the entrance and/or along the length of the conveyor to sense the width of the container and adjust the width adjusters automatically.

The height and width adjustment components can be obtained from Bimba Manufacturing Company (University Park, Ill.)—Linear actuators, Pneumatic components

FIG. 2 shows a top view of a conveyorized system according to one embodiment of the present invention. In this embodiment, the horizontal mover elements 202 as well as the flexible mover elements 204 substantially encapsulate different size and shape containers 208. In this embodiment, the weight of the containers is not supported by the horizontal mover elements 202 or the flexible mover elements 204. In accordance with some embodiments of the invention, the flexible mover elements 204 can function to serve several purposes. One function can include substantially surrounding the circumference of the container 208 and helping the container to maintain its position on the conveyor belt 210. In some embodiments, the container 208 can be maintained in a substantially central position on the belt. Another function can include support the weight of a shrink band 206 in a predefined position vertically along the vertical extent of the container 208 for shrinking at a predefined place. A further function can include moving the shrink band 206 forward at the same speed as the container 208 and maintain the correct positioning in the heat station 218. As the container 208 is conveyed forward shrink bands 206 can be placed about the container 208 and supported by the flexible mover elements 204. The shrink bands 206 can be placed about the container by hand placement, or automatically by a machine. After the shrink band 206 is placed around the container 208, both components enter the heated zone 218. The heated zone 218 can include a preshrink zone or it can complete the entire heat shrinking station for completely shrinking the shrink band 206. The preshrink process can be provided to partially shrink the tamper evident band 206 to tighten it around the container sufficiently to hold it in place such that the heat shrinking process can be completed at another station or another time, such as by using a conventional shrink tunnel. In accordance with some embodiments, the preshrink zone or station and be provided at a location after the shrink band 206 is placed around the container 208 and before the heat zone 218. In some embodiments, the preshrink station can include a separate heat source that partially shrinks the tamper evident band to tighten it in place prior to the heat zone 218. In some embodiments, the preshrink zone can receive heat from the heat zone 218 to partially shrink the tamper evident band in place. A gate or throttle valve can be used to control the flow of heat, such as through a port or a duct from the heat zone 218 to the preshrink zone.

FIG. 3 shows an alternative embodiment of the present invention which includes a banding station 321 for forming a shrink band around a container from a strip or web of shrink material. As shown in FIG. 3, in this embodiment of the invention, two opposing single wound rolls 328 of shrink film 306 can be utilized to create shrink band 306 around a container 308. The single wound rolls 328 can be supported on horizontal unwind plates 330 that can rotate about a vertical axis and enable the rolls 328 to unwind easily. In accordance with some embodiments of the invention, the container 308 can advance forward with the weight of the container 308 resting on the bottom carry belt 310 along the horizontal axis 305. The shrink band material 306 can be suspended over the flexible mover elements 304 with the ends of the two webs of rolls of single wound roll stock 328 fused or sealed together above the flexible mover elements 304. As the container 308 enters the machine the flexible mover elements 304 surround the circumference of the container 308. The container can pass through a sensor 332. The sensor 332 can indicate to the machine when to make a seal around the container by fusing the shrink band material 306 together in the back of the container 308 as it passes along the conveyor 310. The sensor can also signal to the machine for other functions or operations, such as stop the conveyor or feed the single wound film through the film feed system 322. As the container 308 advances into the fused web of single wound shrink film 306, the leading edge of the container 308 can be enveloped by the web of shrink film 306. As the container 308 continues to move forward on the bottom carry conveyor 310 the single wound shrink film rolls 328 unwind and envelope the sides of the container 308 as shown in FIG. 3. When the container is beyond the linear actuators 324, the linear actuators extend toward the center of the conveyor and meet in compression over the center of the opposing flexible mover elements 304 and the conveyor 310. As the linear actuators meet the two webs of shrink material 306 are mated between the elements of sealing device 326 and the webs of shrink film 306 are positioned to be fused together and then cut. The container 308 is enveloped by the shrink film 306 and the sections of shrink film 306 that are mated together behind the container 308 can be fused together to make a continuous shrink band 306 around the container 308. In accordance with some embodiments of the invention, the webs of shrink film 306 can be heat welded together and cut apart from each other, leaving the shrink band 306 around the container 308, resting on the flexible movers 304. In some embodiments, the width of the heat weld can be made sufficiently wide and then cut in the middle of the heat weld so that the shrink film material 306 that has come off of the single wound rolls is welded or fused together in suspension over the flexible movers 304 and ready for the next container 308. The container 308 then advances toward and into the heated zone 318 of the machine where the shrink band 306 can be (optionally, pre-shrunk and then) fully shrunk onto the container 308. The container 308 can then exit the machine. FIG. 3 also shows lead screws 320 which can be used to provide width adjustment. The lead screw 320 allows the horizontal mover assemblies 302 to be moved in and out horizontally, relative to the bottom carry conveyor belt 310 to adjust the system to accommodate containers for various widths.

The roll unwinds 330 support and hold the rolls of shrink film 28 in position while allowing the roll to unwind as the shrink film is fed into the machine. In accordance with some embodiments of the invention, two roll unwinds 330 can be provided, each positioned on opposite sides of the bottom carry belt 310. These unwinds can be mounted in any position as long as the web of shrink film 306 can be fed and positioned at the predefined location along the vertical extent of the container 308.

The film feed system 322 can be provided to help reduce the tension of the web of shrink film 306 relative to the container 308 as it is conveyed by the bottom carry conveyor 310. The film feed system 322 can be driven by a separate motor or it can be driven by the same motor that drives the horizontal movers 302. The film feed system 322 can be variable speed or it can run at a fixed speed. The film feed system 322 can contain a multiple rollers in order to maintain position and the appropriate tension on the web of film 306. The film feed system 322 can, for example, be constructed from drive rollers (part number 22875t68) available from McMaster-Carr Robbinsville, N.J.

The elements of sealing device 326 fuse or fasten together the two ends of the webs of shrink film 306. These webs of shrink film 306 can be fused or fastened together over the top of the flexible mover elements 304. As shown in FIG. 3, the two webs of film 306 can be fused or fastened together after the container has passed the sealing device 326. A sensor 332 can be provided to detect when the container 308 has passed this area. The fusing or fastening can be accomplished by using heat, Ultrasonic technology, glue or solvent welding, cohesive coated film, or radio frequency welding. The elements of sealing device 326 can also cut the web of film 306 creating a completed band around the container 308. The two ends of the webs of single wound film 328 can be fused or fastened together over the center section of the flexible mover elements 304 or at a position closer to one side or the other. In some embodiments, the sealing device 326 can fuse or fasten the film using a chisel pointed edge heated in the range from 200 to 500 degrees F., the nominal temperature can be determined as a function of the thickness of the film to be fused and cut. The horizontal width of chisel pointed edge can be sufficient to fuse an area of the two webs of shrink band material with a sufficient thickness that the fused webs are cut through, but the webs on both sides of the cut remain fused after they are cut through. In some embodiments, the chisel pointed edge can be pressed into a (heated or unheated) planar backing plate to form the fused area. In other embodiments, the chisel pointed edge can be pressed into another (heated or unheated) chisel pointed edge to form the fused area.

The heat station or heated zone 318 shrinks the shrink film 306 around the container 308. The heated zone 18 can provide a partial shrinking of the shrink film 306 or a full shrink of the shrink film 306. If the heated zone 318 only partially shrinks the film, preferably, it should have sufficient heat and/or length to shrink the film 306 sufficiently to hold the shrink film 306 in place after it leaves the flexible mover elements 304. After partial shrinking, the container can be fed into a shrink tunnel or apparatus to finish the shrinking of the band 306 around the container 308. One example of a shrink tunnel is the EZ-SRB manufactured by Axon LLC Raleigh, N.C. The heated zone can, for example, utilize radiant heat, steam heat, or convection heat to shrink the shrink film 306.

In accordance with some embodiments, the linear actuators 324 can be designed or selected to move the sealing devise 326 above the opposing flexible mover elements 304. This enables the two webs of single wound film 328, 306 to be fused or fastened together in a predefined position. The linear actuators can be electric, hydraulic, magnetic, mechanical or pneumatic.

In accordance with the invention, the shrink band material 306, 328 can be made from PLA, PVC, PETG, OPS, or PE, however other polymers can be used. In some embodiments of the invention, the shrink band material 106, 206 can be pre-fabricated into loops or rings that can be dropped or positioned over the container to rest on the flexible mover elements 104, 204. In some embodiments of the present invention, conventional shrink band positioning devices can be used in conjunction with the conveyorized system according to one or more embodiments of the invention to deposit shrink bands 106, 206 on to containers traveling along the conveyor belt 110, 210. In other embodiments of the present invention, such shown in FIG. 3, the shrink band 306 can formed around the container as it passes along the conveyor belt 310. In some embodiments, the shrink band 306 can be formed from two webs 328 of film that are fused or fastened together in front of the container as it passes along on the conveyor 310 and then fused or fastened together behind the container 308 after the container 308 passes the film dispensing components (the film feed components 322 and film roll unwinds 330). In some embodiments, the film 328 can be fused and cut at the same time using a heated edge that heat fuses the two film webs as the heated edge presses them together and then continues to cut through the fused films leaving two fused sections of film, one section forming the back portion of shrink band 306 that was wrapped around the exiting container and another section in front of the entering container. The shrink band film is available, for example, from Klockner Pentaplast (Gordonsville, Va.).

In accordance with an alternative embodiment of the invention, a system without a horizontal carry conveyor can be provided. In this embodiment, the containers or packages to be sealed with a shrink band can be pushed along a horizontal pathway extending between a first horizontal mover and a second horizontal mover, through a band application station that applies the heat shrink band around the container or package as it is pushed through the band application station. At the end of the band application station, a heat zone with a motorized conveyor can be positioned to receive the container or package with the heat shrink band in position on the flexible mover elements to shrink the band in place on the container or package. In some embodiments, a pre-shrink station can be provided to control the application of heat to the band of shrink film to pre-shrink the band of shrink film sufficient to be supported by the container or package until it passes through a heat zone or heat tunnel to completely heat shrink the band of shrink film in place on the container or package. In some embodiments, the pre-shrink station can include a gate that controls the flow of heat from the heat zone or heat tunnel of the heat station to pre-shrink the band of shrink film. In some embodiments, the pre-shrink station can include a separately controlled heat source, either from the side or above, that can be applied to pre-shrink the band of shrink film on the container or package. In this embodiment, instead of using a motorized conveyor, free moving (non-motorized) conveyor belt or a base plate with a smooth surface (e.g. a polished metal plate, or low friction surface, for example, a Teflon coated surface) can be used under the banding station to enable the container or package to slide through the station. In accordance with some embodiments of the invention, a handle, push bar, or push plate can be used, via human intervention, to manually push the container or package through the band application station and onto the conveyor that moves the container or package through the heat zone. In accordance with some embodiments of the invention, a pneumatic or hydraulic actuator (e.g., cylinder or motor) can be used move the handle, push bar or push plate to push the container or package through the band application station. This embodiment can be better suited for small and light weight containers and packages.

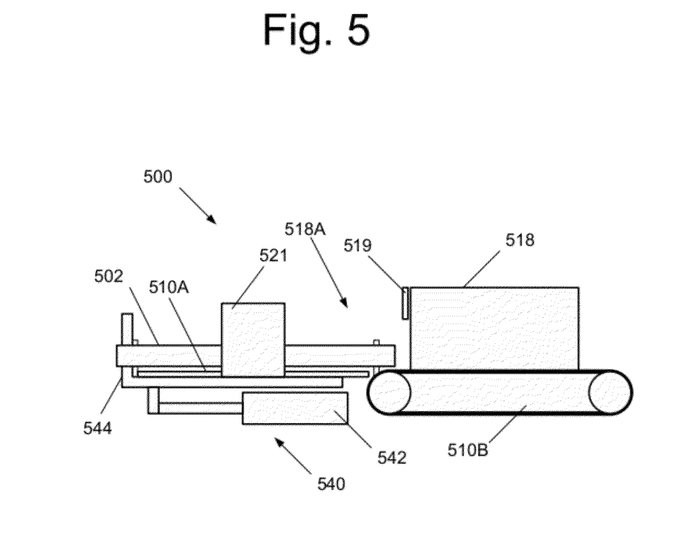

In accordance with some embodiments of the invention, as shown in FIG. 5, the system 500 for applying a band of shrink film on to a container or a package can include a horizontal pathway, such as a support plate 510A extending between a first horizontal mover 502 and a second horizontal mover 502 and including a banding station 521 followed by a pre-shrink station 518A and a heat station 518. In accordance with some embodiments of the invention, each of the first horizontal mover 502 and the second horizontal mover 502 can include a plurality of mover elements (not shown) extending substantially transverse to the horizontal pathway. The mover elements can be substantially flexible such that they engage and surround the container or package as it passes along the horizontal pathway. The mover elements can also be substantially rigid in a vertical direction such that the mover elements can support a band of shrink film in a vertical position with respect to the container or package as it passes along the horizontal pathway. At the band application station 521, a band of shrink film can be applied to encircle the container or package. In some embodiments of the invention, the applied band of shrink film can be pre-formed to the appropriate size and selected according to size and/or shape of the container or package. In some embodiments of the invention, the band of shrink film can be formed by fusing two webs of shrink film together in front of and behind the container or package as it passes through the band application station. In some embodiments, two webs of shrink film can be fused together before the container or package enters the banding station 521 and as the container or package is pushed through the banding station 521, the band of shrink film extends around both sides of the container or package and the two webs can be joined together by fusing behind the container or package as it leaves the banding station 521. The fusing operation can, at the same time or subsequent to fusing, cut the shrink film from the container leaving a band of shrink film formed around the container or package. At the pre-shrink station 518A, heat can be applied to the band of shrink film to pre-shrink the band in place prior to entry into the heat station 518. In accordance with one embodiment, a gate 519 can be provided that enables some of the heat from the heat station 518 to flow toward the band of shrink film as it moves toward the heat station 518. In some embodiments, the movement of the handle, push bar or push plate 544 can be connected by gears, chains or cables to open the gate as the container is moved toward the heat station 518. In some embodiments, a sensor can be used to detect the container moving into position and activate an actuator, such as a motor or solenoid to open the gate, for example, for a predefined period of time, to apply heat to pre-shrink the band of shrink film. At the heat station 518, the container or package can be transferred to a horizontal carry conveyor 510B that carries the container or package with the pre-shrunk band through the heat station 518 to complete the heat shrink process such that the band of shrink film is completely heat shrunk in place.

In accordance with some embodiments of the invention, a handle, push bar or push plate 544 can be used to move the container or package through the banding station 512 and into the heat station 518. The handle, push bar or push plate 544 can extend around the support plate 510A that defines the horizontal pathway or the support plate 510A can include a central slot through which a portion of the handle, push bar or push plate 544 extends. The handle, push bar or push plate 544 can be manually pushed through the banding station 521 or an actuator system 540 can be provided. In accordance with some embodiments of the invention, the actuator system 540 can include pneumatic or hydraulic cylinder 542 that coupled to the handle, push bar or push plate 544 to push the container or package through the banding station 521, such as by pressing a button or foot pedal or other control element, for example, after the operator has removed their hands from the system 500. The motion of the horizontal movers 502 can be coupled to the handle, push bar or push plate 544 to enable the motion of the handle, push bar or push plate 544 to drive the horizontal movers at substantially the same speed as the container or package is moved through the band application station. The coupling can be adapted to drive in one direction and slip in the other to enable the handle, push bar or push plate 544 to be moved in the opposite direction to accept the next container or package. In one embodiment, a set of gears can connect the handle, push bar or push plate 544 to the horizontal movers 502 with at least one gear being ratcheted or slipping in one direction. In another embodiment, the handle, push bar or push plate 544 can be coupled to a rack that engages a pinion gear that is coupled to the horizontal movers 502, for example, by additional gears or one or more chains and sprockets, such that movement of the handle, push bar or push place drives the horizontal movers 502 at about the same speed. Alternatively, a cable and pulley system can be used to connect the handle, push bar or push plate 544 to horizontal movers 502 using at least one pulley slips in one direction to enable the handle, push bar or push plate 544 to move in one direction without moving the horizontal movers 502.

In accordance with some embodiments of the invention, two sets of horizontal movers can be provided. A first set of horizontal movers can be provided in the band application station and a second set of horizontal movers can be provided in the conveyorized heat zone. The first set of horizontal movers can be free to move with the container or package as it is moved through the band application station. The second set of horizontal movers can be coupled to the conveyor of the heat zone to support the heat shrink band as the container or package travels through the heat zone.

In accordance with some embodiments of the invention, horizontal movers can be coupled to the conveyor in the heat zone such that the flexible elements of the horizontal mover travel at about the same speed as the heat zone conveyor. In this embodiment, the container or package can be pushed (e.g., manually or by pneumatic or hydraulic actuation) through the band application station at about the same speed as the horizontal movers move through the band application station and into the heat zone.

### LIST OF COMPONENTS (WHERE n=Fig. no.)

n02 Horizontal movers

n04 Flexible mover elements

n05 Horizontal Axis

n06 Shrink band material or film

n08 Containers of random sizes and shapes

n10 Bottom carry conveyor

n10A Support plate

n10B Horizontal Carry Conveyor

n12, 14 Support rollers

n16 lead screws for height adjustment

n18 heated zone for shrinking film

n18A pre-shrink zone/station

n20 Lead screws for horizontal adjustment

n21 Banding Station

n22 film feed system

n24 Linear actuators

n26 Sealing device

n28 Single wound shrink film rolls

n30 Roll unwinds

n32 Sensor for sensing containers

n40 Actuator System

n42 Pneumatic or Hydraulic Cylinder

n44 Handle, Push Bar or Push Plate

Other embodiments are within the scope and spirit of the invention. Features implementing functions may also be physically located at various positions, including being distributed such that portions of functions are implemented at different physical locations. Further, while the description above refers to the invention, the description may include more than one invention.

1. A conveyorized system comprising:
a conveyor extending along a horizontal axis, the conveyor including a horizontal belt adapted to support and move a container over a predefined distance along the horizontal axis;
a first horizontal mover and a second horizontal mover extending parallel to the horizontal axis along opposite sides of the conveyor;
each horizontal mover including a plurality mover elements extending substantially transverse to the horizontal axis.

2. A conveyorized system according to claim 1 further comprising a heat station adapted to preshrink a heat shrink band.

3. A conveyorized system according to claim 1 further comprising a heat station adapted to shrink a heat shrink band.

4. A conveyorized system according to claim 1 further comprising a banding station adapted to apply a heat shrink band to a container traveling on the conveyor, wherein at least a portion of the heat shrink band is support by the mover elements of at least one of the first horizontal mover and the second horizontal mover.

5. A conveyorized system according to claim 4 wherein the banding station forms the heat shrink band by wrapping a band of heat shrink film around the container.

6. A conveyorized system according to claim 4 wherein the banding station places a preformed heat shrink band around a portion of the container.

7. A conveyorized system according to claim 1 further comprising a banding station adapted to apply a heat shrink band to a container traveling on the conveyor, wherein at least a portion of the heat shrink band is support by the mover elements of at least one of the first horizontal mover and the second horizontal mover;
wherein the banding station is adapted to form the heat shrink band by fusing two webs of heat shrink film in front of the container, wrapping a web of heat shrink film around each side of the container as the container travels along the horizontal axis and by fusing the two webs of heat shrink film behind the container as the container passes through the banding station.

8. A conveyorized system according to claim 1 further comprising a banding station adapted to apply a heat shrink band to a container traveling on the conveyor, wherein at least a portion of the heat shrink band is support by the mover elements of at least one of the first horizontal mover and the second horizontal mover;
wherein the banding station includes a first source of a web of heat shrink film and a second source of a web of heat shrink film and a web fusing element adapted to fuse a portion of a web of heat shrink film from the first source to a portion of a web of heat shrink film from the second source.

9. The conveyorized system according to claim 8 wherein the web fusing element includes a heated edge that is pressed into the two webs of the heat shrink film.

10. A system for applying a shrink band on a container, the system comprising;
a horizontal pathway extending between a first horizontal mover and a second horizontal mover, the first horizontal mover and the second horizontal mover each including a plurality of mover elements extending transverse to the horizontal pathway;
a banding station positioned along the horizontal pathway, the banding station including at least one band of heat shrink film and a positioning mechanism adapted to position a band of heat shrink film around the container, whereby the band of heat shrink file is supported by the mover elements.

11. A system according to claim 10 further comprising a push element aligned with the horizontal pathway to push the container along the horizontal pathway through the banding station.

12. A system according to claim 10 further comprising a pre-heat station positioned along the horizontal pathway after the banding station, the pre-heat station providing access to a source of heat, whereby the source of heat pre-shrinks the band of shrink film onto the container.

13. A system according to claim 10 wherein the banding station includes a first source of a web of heat shrink film and a second source of a web of heat shrink film and a web fusing element adapted to fuse a portion of a web of heat shrink film from the first source to a portion of a web of heat shrink film from the second source and the band of heat shrink film is form by wrapping at least one web of heat shrink film around the container.

14. A method for applying a shrink band to container comprising:
moving the container along a horizontal pathway;
providing at least one flexible mover element in position next to the container;
placing a band of heat shrink film around the container; and
supporting the band of heat shrink film at a substantially a predefined vertical height with respect to the container.
